(19) United States
(12) Patent Application Publication
(10) Pub. No.: US 2004/0025455 A1
(43) Pub. Date: Feb. 12, 2004

(54) Fire-resistant, smoke-tight sliding door

(76) Inventors: Thorsten Nubel, Aschendorf (DE); Dorothea Nubel, Aschendorf (DE)

Correspondence Address: MCGLEW & TUTTLE, PC, SCARBOROUGH STATION, SCARBOROUGH, NY, 10510, US

(21) Appl. No.: 10/424,261

(22) Filed: Apr. 28, 2003

(30) Foreign Application Priority Data
Apr. 29, 2002 (DE) DE 202 06 749.1

(51) Int. Cl. E06B 3/32

(52) U.S. Cl. 52/204.51

(57) ABSTRACT

A fire-resistant smoke-tight sliding door is provided which has at least one door leaf (1), which can be moved in a plane. The leaf (1) is made of fire-resistant glass and is accommodated in a frame (2). The door includes a conveying device, wherein the conveying device (3) has at least one track profile (4) mounted rigidly on a wall and at least one carrying element (5) connected to the frame (2). The carrying element (5) has at least one axle (6) with a conveying roller (7) mounted rotatably thereon with a said running surface (8) made of plastic. The conveying roller (7) has a core (9) made of a fire-resistant material.

### FIELD OF THE INVENTION

The present invention pertains to a fire-resistant, smoke-tight sliding door which has at least one door leaf, which can be moved in a plane, is made of fire-resistant glass, and is accommodated in a frame, as well as a conveying device with a track rigidly on a wall and a carrying element connected to the frame.

### BACKGROUND OF THE INVENTION

A fire-resistant, smoke-tight sliding door, which has at least one door leaf that is movable along one plane and is made of fire-resistant glass, is disclosed, e.g., in EP 0 666 403 A1. The sliding door disclosed in this document is equipped with a frame for the glass and has a conveying device. The conveying device comprises at least one track profile mounted rigidly on the wall and at least one carrying element connected to the frame, wherein at least one axle with a conveying roller mounted rotatably on it with a running surface made of plastic is fastened to the carrying element. The sliding door is accommodated within a frame structure. A deliberate destruction of the conveying device is used in case of fire to bring about the lowering of the sliding door wing in the vertical direction, i.e., in the direction of the plane of the sliding door, so that smoke tightness of the sliding door is achieved as a result. The conveying device is made of a low-melting plastic material for this purpose. Materials that melt on heating are introduced into the frame profiles to improve the smoke tightness. However, one essential drawback of the solution known from this document is that the sliding door, once lowered, can no longer be moved. A sliding door thus blocked cannot be used, e.g., in areas in which the evacuation of persons would thus be jeopardized. A possibility of escape must be preserved in such an arrangement for emergencies at least conditionally. The conveying rollers of the conveying device, which are described in EP 0 666 403 A1, consist of plastic and have very good running properties. Thus, more than one million movement cycles of a sliding door can be readily achieved with such rollers, which is especially advantageous in case of the use of the conveying rollers on sliding doors for public areas frequented by many people. Conveying rollers made of plastic can therefore be better used here than steel rollers, with which only 200,000 movement cycles can be reached and which are, moreover, disadvantageous because of their running noise.

However, as was stated above, the drawback of the plastic rollers is that they melt at high temperature as they occur in case of fire. A sliding door thus equipped would no longer be able to function. However, modern sliding doors must meet fire protection qualities such as T30 and higher, which would not be possible with a prior-art sliding door with conveying rollers made of plastic.

### SUMMARY OF THE INVENTION

The basic object of the present invention is to provide a fire-resistant, smoke-tight sliding door, with which long service life can be expected besides smooth running in operation and is also smoke-tight and is able to function in case of fire at least to a limited extent and makes emergency evacuation possible.

According to the present invention a fire-resistant, smoke-tight sliding door is provided. The door has at least one door leaf made of fire-resistant glass, which door leaf is movable along a plane and is accommodated in a frame. The door has a conveying device with at least one track profile mounted rigidly on the wall and at least one carrying element connected to the frame. Each carrying element has at least one axis with a conveying roller mounted on it rotatably and with a running surface made of plastic. The conveying roller has a core made of a fire-resistant material.

Due to such a design, the conveying roller can have a long service life and yet guarantee very good running properties as well as a safety function in case of fire. Thus, the conveying roller has a running surface made of plastic, which, though melting above a temperature limit, can nevertheless maintain the function of the sliding door at least to a limited extent, because the core consists of a fire-resistant material of higher strength. Thus, the solution according to the present invention makes it possible for the first time ever to also use sliding doors for an area with fire hazard, i.e., as fire doors. The solution is very simple and it can thus also be used for already existing systems by retrofitting.

According to one embodiment of the present invention, it is proposed that the core of the conveying roller be made of, e.g., ceramic, asbestos or metal. If metal is to be used, a steel core within the conveying roller may be preferably advantageous.

Since only the core of the conveying roller is left remaining, upon the occurrence of a fire due to the melting of the plastic of the running surface, the core must roll along on a correspondingly associated track profile. This can be achieved, on the one hand, by the core itself being provided with a running surface geometry. On the other hand, it is also possible for a conveying roller according to the present invention for a fire-resistant, smoke-tight sliding door to be limited laterally by, e.g., two disks arranged on both sides of the running surface of the conveying roller. After the melting off of the plastic, these disks form a kind of catching system and guarantee, furthermore, the guiding of the roller on the track profile. The disks thus additionally contribute to guaranteeing an emergency running system of a fire-resistant, smoke-tight sliding door according to the present invention. The disks are preferably made of metallic materials. However, it is, of course, also possible to use other materials, e.g., ceramics.

A combination of the above-described designs is also within the scope of the present invention. For example, the core may thus be provided with a running surface geometry and the conveying roller may have a disk each on its outer sides.

According to a variant of the present invention, it is proposed, moreover, to optimize the smoke tightness of a fire-resistant, smoke-tight sliding door according to the present invention that the sliding door have a smoke-tight sliding seal above and below its door leaf, i.e., above and below the visible, clear area. Sliding seals are of decisive advantage because the function of the sliding door remains nearly unaffected thereby. They offer very little resistance to the normal operation of the sliding door and run with low noise and friction. The sliding seal may be advantageously designed such that it comprises at least one sealing lip present at the door leaf or at the frame, which is slidingly in contact with at least one corresponding sealing profile mounted rigidly on the wall.

Another possible design of a sliding seal for a fire-resistant, smoke-tight sliding door can be seen in that the sliding seal comprises at least one sealing lip present at the door leaf or at the frame, which is accommodated in at least one corresponding sealing profile mounted rigidly on the wall when the sliding door is closed. For example, two individual sealing profiles arranged in parallel to one another may be used as the sealing profiles. These are located at such a distance from one another that permits the sealing lip of the sliding door to be introduced. Bilateral smoke tightness of a sliding door according to the present invention is thus achieved.

The sliding seal described in the introduction may be provided in both a horizontal and vertical arrangement.

The vertical arrangement of a smoke-tight sliding seal for a sliding door according to the present invention can be designed such that the sealing profile has an outer edge rising in relation to the floor plane in the closing direction of the sliding door and the sealing lip has an outer edge descending in the opposite direction, so that the sealing profile and the sealing lip are sealingly in contact with one another in an overlapping arrangement with the sliding door closed. Due to such a design, the sealing area is enlarged with increasing closing path of the sliding door, while the seals are not in contact when the sliding door is open.

The horizontal arrangement of such a sliding seal may be characterized, e.g., in that the sealing profile has an outer edge extending at an acute angle toward the sliding door relative to the plane of the sliding door in the closing direction of the sliding door, and the sealing lip has an outer edge extending in an opposite pattern in relation to the sealing profile, so that the sealing profile and the sealing lip are arranged sealingly in contact with one another in an overlapping position when the sliding door is closed.

The decision in favor of the vertical or horizontal arrangement of such a sliding seal should be based mainly on structural aspects. The mode of operation is equivalent with both designs.

During a fire, a fire-resistant, smoke-tight sliding door according to the present invention should be lowered by a small amount, i.e., e.g., between 4 mm and 8 mm, after the melting off of the conveying roller in order to continue to make possible the function of the sliding door. Lowering by 6 mm is preferred.

The long service life of the conveying device of the sliding door can be improved by mounting the conveying rollers in ball bearings.

To further improve the safety, it is, moreover, conceivable to provide an additional rescue route next to the sliding door. At least one revolving or folding door is proposed for the solution. This revolving or folding or swinging door may be integrated on the side directly in the frame of the sliding door and be designed as a door pivoting on hinges. The revolving or folding or swinging door is fixed according to the present invention during the normal operation of the sliding door, i.e., it is fixed in the frame or closed. It can be opened when needed by means of a panic key in order to make it possible to use the revolving or folding door as a rescue route. It is, of course, necessary to take precautionary measures that will automatically close the revolving or folding or swinging door immediately after it had been opened.

This can be achieved, e.g., by means of springs or other means, i.e., by automatically acting closing mechanisms.

Preferred embodiments of a fire-resistant, smoke-tight sliding door according to the present invention will be explained in greater detail below with reference to the corresponding drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a sectional view through a conveying device;

FIG. 2 is a detail of a sectional view through the underside of an embodiment of a sealing area of a sliding door according to the present invention;

FIG. 3 is a detail of a sectional view through the underside of another embodiment of a sealing area of a sliding door according to the present invention;

FIG. 4 is a detail of a sectional view through the underside of another embodiment of a sealing area of a sliding door according to the present invention;

FIG. 5 is a detail of a sectional view through the underside of another embodiment of a sealing area of a sliding door according to the present invention;

FIG. 6 is a detail of a sectional view through the underside of another embodiment of a sealing area of a sliding door according to the present invention;

FIG. 7 is a detail of an opened sliding door;

FIG. 8 is a detail of a closed sliding door, and

FIG. 9 is a sliding door with a folding door each on both sides.

### DESCRIPTION OF THE PREFERRED EMBODIMENTS

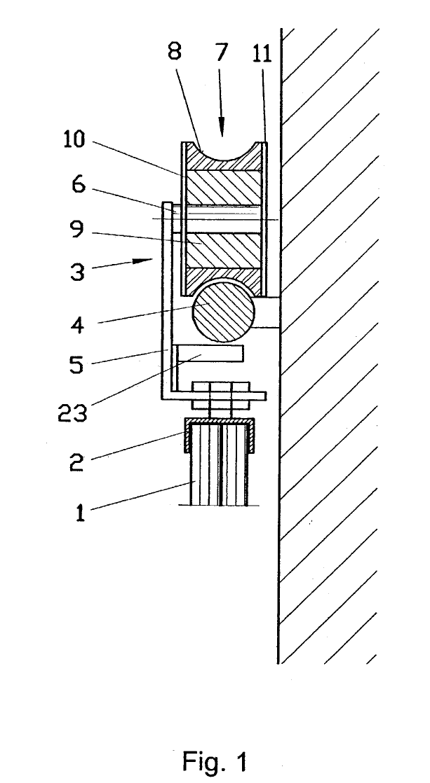

Referring to the drawings in particular, FIG. 1 shows a detail and a sectional view of a conveying device designated as a whole by 3 for a sliding door of a fire-resistant and smoke-tight design. This conveying device 3 comprises a track profile 4, which is mounted rigidly on the wall. A conveying roller 7 with a running surface 8 made of plastic rolls on the track profile 4. The core 9 of the conveying roller 7 is formed by a steel core. An axle 6 is used as the bearing axis of the conveying roller 7 within the steel core 9. The axle 6 is connected to a support element 5. The support element 5 is also used at the same time to accommodate the door leaf 1. The connection between the door leaf 1 and the support element 5 is formed by a frame 2. The frame 2 encloses the sliding door glass panes. In the example of FIG. 1 the door panes are provided as a plurality of glass panes with the frame 2 all around in the manner of a frame.

Under the track profile 4, the conveying device 3 has, furthermore, a lifting device 23, which prevents the undesired lifting off of the conveying roller 7 from the track profile 4.

The conveying roller 7 has a respective disk 10 and 11 each on both sides of the running surface 8, which form a catch system also after the melting off of the plastic of the running surface 8 due to a fire and continue to guarantee an emergency running function of the sliding door together with the core 9 of the conveying roller 7, so that persons who may have to be evacuated can be brought through the sliding door.

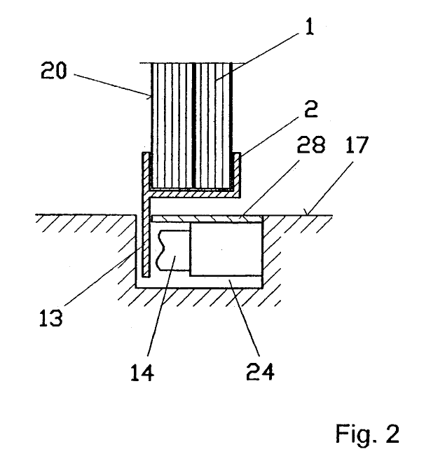

FIG. 2 shows the underside of a sliding door of a fire-resistant, smoke-tight design. A composite glass system from two glass panes, which together form a door leaf 1, is used here as well. This door leaf is accommodated in a frame 2. The frame 2 passes here over into an area that acts as a sealing lip 13. With the sliding door closed, a sealing profile 14, which is arranged in a recess 24 under the floor plane 17, comes into contact with this sealing lip 13. The sealing profile 14 is thus arranged outside the visible area during the normal operation of the sliding door. A cover plate 28 in the floor covering area of this sliding door is used to visually cover this sealing profile 14.

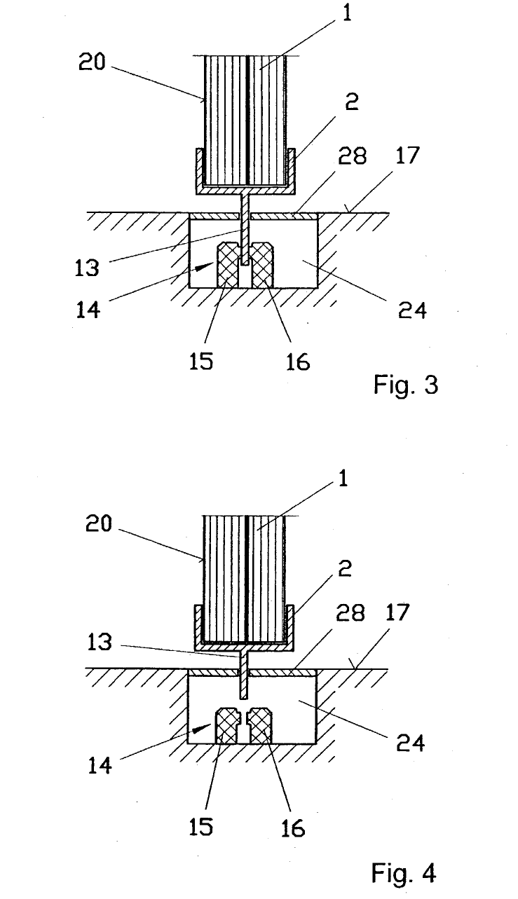

FIGS. 3 and 4 show another embodiment of a sliding seal 12, as can be manufactured in the vertical design. FIG. 3 illustrates the closed state of the sliding door and FIG. 4 the opened state. The frame 2 of the sliding door shown in FIGS. 3 and 4 passes over into the sealing lip 13 approximately in the middle of the door leaf 1. As is apparent from FIG. 3, this sealing lip is accommodated slidingly and also guided between two individual sealing profiles 15 and 16.

The sealing profile 14 has a contour rising in the closing direction of the sliding door. The contour of the sealing lip 13 of the sliding door extends in the opposite direction, which can be recognized from the sectional views in FIGS. 3 and 4, and leads to an increasing coverage of the seals, which is proportional to the travel of the sliding door during closing. The sealing profiles 14 are arranged in a recess 24 outside the visible area in the embodiments according to FIGS. 3 and 4 as well. A cover plate 28 is used for covering. The sealing profiles 14 are thus recessed under the floor plane 17.

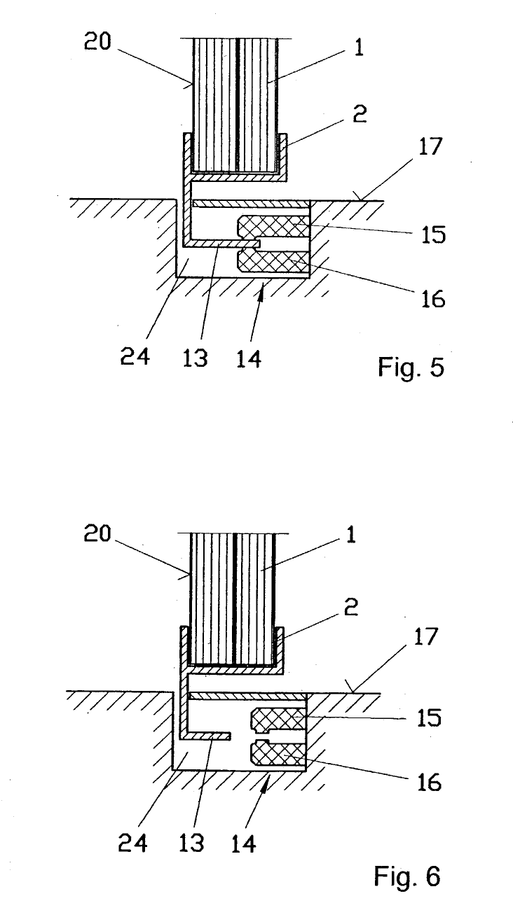

Another embodiment of the smoke-tight design of a fire-resistant sliding door is shown in FIGS. 5 and 6. A horizontal sliding seal 12 is shown here. The door leaf 1 of the sliding door, which comprises two individual glass panes, is accommodated in a frame 2. The frame 2 passes over into a sealing lip 13, which extends at first vertically under the floor plane 17 and passes over within the recess 24 into an area descending at an angle, which extends nearly horizontally here. To assume its sealing function, the sealing lip 13 slides between two individual profile seals 15 and 16, which together form the sealing profile 14.

FIG. 5 shows the closed state of a sliding door, while FIG. 6 shows the opened state. The sealing lip 13 and the sealing profile 14 have contours rising in opposite directions in this case as well, so that the coverage of the sealing surfaces also increases with the closing of the sliding door.

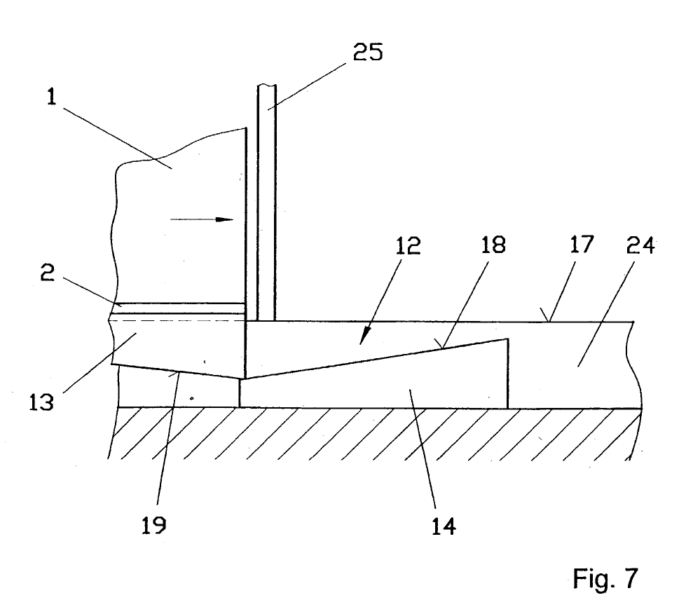

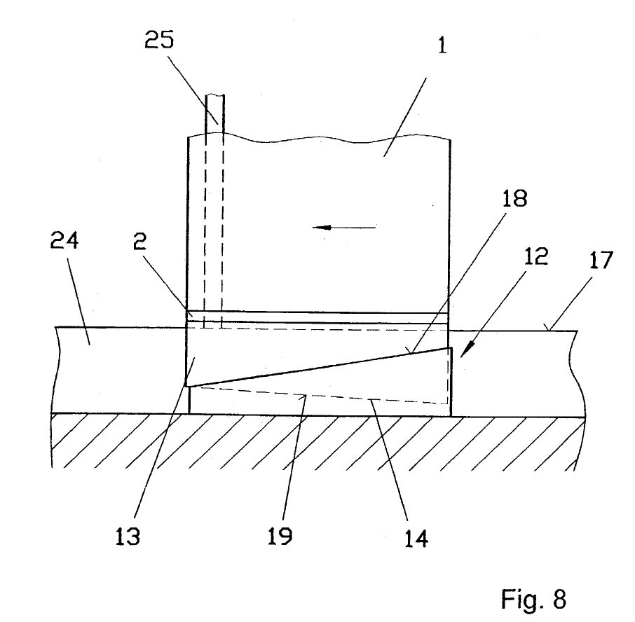

FIGS. 7 and 8 show once again an enlarged view of a sliding seal 12 as was already explained in FIGS. 3 and 4. This seal for a fire-resistant, smoke-tight sliding door, called a vertical seal, comprises a door leaf 1, which is accommodated in a frame 2. The frame 2 passes over into a sealing lip 13 located under the floor plane 17. The geometric height of the outer edge 19 of the sealing lip 13 increases when viewed in the closing direction of the sliding door. The sliding door construction is as a whole part of a frame 25, which is shown only partially in FIGS. 7 and 8. A corresponding sealing profile 14 is arranged within the recess 24 under the floor plane 17. This sealing profile 14 has an outer edge 18 rising in the closing direction of the sliding door. Thus, it has a ramp-like shape. The sealing profile 14 may comprise two individual sealing profiles 15 and 16 in this case as well.

Additional smoke tightness can be achieved with the expanding materials provided within the frame, which are intentionally caused to expand or expand spontaneously due to heating as a consequence of the fire. The materials suitable for this include, e.g., Promaseal, as is already known from other fire doors.

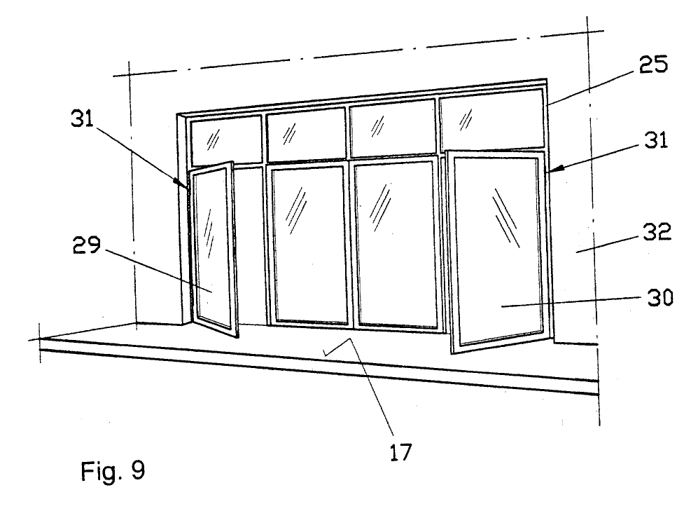

FIG. 9 shows, moreover, another embodiment of a sliding door according to the present invention. A respective folding door 29 and 30 each is accommodated here in the frame 25 of the sliding door laterally next to the sliding door, and the folding doors open an additional rescue route should this become necessary. The frame 25 is fitted into a wall 32 of a building. The respective folding doors 29 and 30 are mounted in the frame 25 pivotably around hinges 31 and as long as they are not used, they are closed with a panic key, not shown in FIG. 9, or are firmly connected to the frame 25 in another manner.

While specific embodiments of the invention have been shown and described in detail to illustrate the application of the principles of the invention, it will be understood that the invention may be embodied otherwise without departing from such principles.

APPENDIX
List of References Numbers

| | |
|---|---|
| 1 | Door leaf |
| 2 | Frame |
| 3 | Conveying device |
| 4 | Track profile |
| 5 | Carrying element |
| 6 | Axle |
| 7 | Conveying roller |
| 8 | Running surface |
| 9 | Core |
| 10 | Disk |
| 11 | Disk |
| 12 | Sliding seal |
| 13 | Sealing lip |
| 14 | Sealing profile |
| 15 | Individual sealing profile |
| 16 | Individual sealing profile |
| 17 | Floor plane |
| 18 | Outer edge |
| 19 | Outer edge |
| 20 | Sliding door plane |
| 21 | Guide element |
| 22 | Guide element |
| 23 | Lifting device |
| 24 | Recess (Depression) |
| 25 | Frame |
| 26 | Setting means |
| 27 | Setting means |
| 28 | Cover plate |
| 29 | Folding door |
| 30 | Folding door |
| 31 | Hinge |
| 32 | Wall |

What is claimed is:

1. A fire-resistant smoke-tight sliding door, comprising:
a door leaf movable in a plane, said door leaf including a fire-resistant glass;
a frame accommodating said fire-resistant glass;
a conveying device with a track profile mounted rigidly with respect to a wall and at least one carrying element connected to said frame, said carrying element having an axle with a conveying roller mounted rotatably thereon, said conveying roller having a running surface made of plastic with a core made of a fire-resistant material.

2. A fire-resistant smoke-tight sliding door in accordance with claim 1, wherein said core of said conveying roller consists of ceramic, asbestos or metal.

3. A fire-resistant smoke-tight sliding door in accordance with claim 1, wherein said running surface of said conveying roller is limited on each side of said conveying roller by a disk.

4. A fire-resistant smoke-tight sliding door in accordance with claim 3, wherein said disks are metal disks.

5. A fire-resistant smoke-tight sliding door in accordance with claim 1, further comprising a smoke-tight sliding seal above and under a visible part of said door leaf.

6. A fire-resistant smoke-tight sliding door in accordance with claim 5, wherein said sliding seal comprises at least one sealing lip present at said door leaf or at said frame and slidingly in contact with at least one corresponding sealing profile mounted rigidly relative to the wall at least when the sliding door is closed.

7. A fire-resistant smoke-tight sliding door in accordance with claim 5, wherein said sliding seal comprises at least one sealing lip provided at said door leaf or at said frame, said sealing lip being accommodated in at least one corresponding sealing profile mounted rigidly on the wall at least when the sliding door is closed.

8. A fire-resistant smoke-tight sliding door in accordance with claim 7, wherein said sealing profile comprises two individual sealing profiles arranged in parallel to each other.

9. A fire-resistant smoke-tight sliding door in accordance with claim 7, wherein said sealing profile has a outer edge rising in relation to a floor plane in a closing direction of the sliding door, and said sealing lip has an outer edge descending in the opposite direction, so that said sealing profile and said sealing lip are arranged sealingly in contact with one another in an overlapping position when the sliding door is closed.

10. A fire-resistant smoke-tight sliding door in accordance with claim 7, wherein said sealing profile has a outer edge extending at an acute angle in relation to said sliding door plane and said sealing lip has a outer edge extending in a direction opposite said sealing profile in the closing direction of the sliding door; so that said sealing profile and said sealing lip are arranged sealingly in contact with one another in an overlapping position when the sliding door is closed.

11. A fire-resistant smoke-tight sliding door in accordance with claim 1, wherein the sliding door is lowered by 4 mm to 8 mm when said running surface of said conveying roller has melted off.

12. A fire-resistant smoke-tight sliding door in accordance with claim 1, wherein said conveying roller has a ball bearing.

13. A fire-resistant smoke-tight sliding door in accordance with claim 1, further comprising: a folding door integrated in said frame of the sliding door, with said folding door closed when not in use and opened by means of a panic key when needed, said folding door being arranged on the side of the sliding door to provide an additional rescue route.

14. A fire-resistant smoke-tight sliding door in accordance with claim 13, wherein said folding door is pivotable around hinges.

15. A fire-resistant smoke-tight sliding door in accordance with claim 2, wherein said running surface of said conveying roller is limited on each side of said conveying roller by a disk.

16. A fire-resistant smoke-tight sliding door in accordance with claim 7, wherein the sliding door is lowered by 4 mm to 8 mm when said running surface of said conveying roller has melted off.
